(19) United States
(12) Patent Application Publication
(10) Pub. No.: US 2025/0028328 A1
(43) Pub. Date: Jan. 23, 2025

(54) INTELLIGENT VEHICLES, SYSTEMS, AND CONTROL LOGIC FOR DYNAMIC, EXTERNAL CONTROL OF VEHICLES USING VISIBLE OR AUDIBLE CUES

(71) Applicant: GM Global Technology Operations LLC, Detroit, MI (US)

(72) Inventors: Umer Khalid, Farmington Hills, MI (US); Russell A. Patenaude, Macomb Township, MI (US); Suresh Munagapati, Cumming, GA (US); Jeremy A. Salinger, Southfield, MI (US)

(73) Assignee: GM Global Technology Operations LLC, Detroit, MI (US)

(21) Appl. No.: 18/908,148

(22) Filed: Oct. 7, 2024

Related U.S. Application Data
(63) Continuation-in-part of application No. 18/304,431, filed on Apr. 21, 2023.

(51) Int. Cl. G05D 1/227; B60W 30/182; H04L 9/40; H04W 4/44

(52) U.S. Cl. CPC G05D 1/2272; B60W 30/182; H04L 63/08; H04W 4/44

(57) ABSTRACT

Presented are intelligent vehicle control systems enabling external control of vehicles using cues, methods for making/using such vehicle control systems, and vehicles equipped with such control systems. A method of controlling operation of a vehicle includes a vehicle controller receiving a signal indicating the vehicle is in particular operating mode and, responsive to receiving a cue, determine if a command is executable and, if so, executing the command.

### CROSS-REFERENCE TO RELATED APPLICATIONS

This application claims priority as a continuation-in-part to non-provisional application Ser. No. 18/304,431, titled “Intelligent Vehicles, Systems, and Control Logic for External Control Of Vehicles Using Visible or Audible Cues,” filed Apr. 21, 2023, which is hereby incorporated by reference in its entirety herein.

### FIELD OF INVENTION

The present disclosure relates generally to intelligent control systems of motor vehicles. More specifically, aspects of this disclosure relate to systems, methods, and devices for dynamically provisioning automated vehicle control using visible or audible cues.

### BACKGROUND

Motor vehicles, such as automobiles, may be equipped with a network of onboard electronic devices that provide automated driving capabilities to help minimize driver effort. In automotive applications, for example, one of the most recognizable types of automated driving features is the cruise control system. Cruise control allows a vehicle operator to set a particular vehicle speed and have the onboard vehicle computer system maintain that speed without the driver operating the accelerator or brake pedals. Next-generation Adaptive Cruise Control (ACC) is an automated driving feature that regulates vehicle speed while concomitantly managing headway spacing between the host vehicle and a leading “target” vehicle. Another type of automated driving feature is the Collision Avoidance System (CAS), which detects imminent collision conditions and provides a warning to the driver while also taking preventative action autonomously, e.g., by steering or braking without driver input. Intelligent Parking Assist Systems (IPAS), Lane Monitoring and Automated Steering (“Auto Steer”) Systems, Electronic Stability Control (ESC) systems, and other Advanced Driver Assistance Systems (ADAS) are also available on many automobiles.

As vehicle processing, communication, and sensing capabilities continue to improve, manufacturers will persist in offering more automated driving capabilities with the aspiration of producing fully autonomous “self-driving” vehicles competent to operate among heterogeneous vehicle types in both urban and rural scenarios. Original equipment manufacturers (OEM) are moving towards vehicle-to-vehicle (V2V) and vehicle-to-infrastructure (V2I) “talking” cars with higher-level driving automation that employ intelligent control systems to enable vehicle routing with steering, lane changing, scenario planning, etc. Automated path planning systems utilize vehicle state and dynamics sensors, geolocation information, map and road condition data, and path prediction algorithms to provide route derivation with automated lane center and lane change forecasting.

Many automobiles are equipped with an in-vehicle telecommunications and informatics (“telematics”) unit that provides vehicle navigation, control, entertainment, and other desired functionalities. Wireless-enabled telematics units, in addition to enabling vehicle occupants to connect to the Internet and communicate with a centralized back-office (BO) host vehicle service, may enable an owner or driver of the vehicle to interact with the telematics unit via a cellular or short-range comm link using a smartphone or similar device. For instance, the owner/driver may misplace the keys to the vehicle or lock the keys inside the vehicle; the user may use their smartphone to communicate with the telematics unit to unlock a vehicle door. Additionally, an owner/driver who forgets where they parked the vehicle in a parking garage may wirelessly communicate with the telematics unit using their smartphone to activate the vehicle's horn and/or car lights. Generally speaking, wireless communications with and remote control of a vehicle is typically limited to the vehicle owner or an authorized driver of the vehicle and necessitates a wireless-enabled computing device and prior user authentication.

### SUMMARY

Presented herein are intelligent vehicle systems with attendant control logic for provisioning external control of vehicles using visible and audible cues, methods for making and methods for operating such vehicle control systems, and motor vehicles equipped with such control systems. By way of example, there is presented a system and method for controlling a vehicle externally using signs, sounds, verbal commands, gestures, etc. The method may enable dynamic assignment of external vehicle control to previously registered or unregistered third parties, first responders, and preauthorized users, such as a vehicle owner or driver. Under exigent circumstances, such as a vehicle collision event or an emergency situation, the vehicle control system may enable a person standing outside the host vehicle to safely and securely move the vehicle using hand motions, verbal commands, or other visible/audible inputs that are perceptible by the vehicle's networked sensor array. One of three different operating modes—automatic, manual, and remote—may be triggered to assign distinct levels of vehicle control based on vehicle sensor feedback, contextual data, vehicle state, remote user identify, etc. Limitations of preauthorization for specific individuals or credential exchanges on a device may be eliminated by utilizing a flexible algorithm that determines when and to what extent the functionality is necessary.

Attendant benefits for at least some of the disclosed concepts include enhanced vehicle control protocols that dynamically enable external control of a host vehicle using visible and/or audible cues without requiring prior authentication or recognition of the cue-generating entity. Disclosed vehicle control protocols enable a first responder or pedestrian to gain access to and/or safely relocate a host vehicle during any one of multiple predefined urgent situations without the need for a wireless-enabled computing device or access to the passenger compartment. Other attendant benefits may include control protocols that enforce a hierarchy of command authority, such as different operating modes assigned distinct levels of command with associated sets of authorized controls. The enforced hierarchy helps the host vehicle to dynamically expand or restrict external user control. The vehicle may enable an external entity to submit a formal request or enter a predefined gesture or a set of credentials for enhanced control approval. If a preset threshold of identification is not met, the host vehicle or a remote authorization unit may restrict or deny external control.

Aspects of this disclosure are directed to intelligent vehicle control systems, system control logic, and memory-stored instructions for provisioning external control of vehicles using visible and audible cues. In an example, a method is presented for controlling operation of a host vehicle having a resident or remote controller or module or network of controllers/modules (collectively “controller” or “vehicle controller”) and an on-vehicle network of sensing devices (e.g., radar transceiver(s), LiDAR scanner(s), high-definition video camera(s), microphone(s), short-range radio transceiver(s), magnetometers, etc.). This exemplary method includes, in any order and in any combination with any of the above and below disclosed options and features: receiving, e.g., via the vehicle controller from an in-vehicle telematics unit, an automatic trigger signal indicating the host vehicle is in any one of multiple predefined automatic control trigger states; activating, e.g., via the vehicle controller in cooperation with an ADAS module responsive to receiving the automatic trigger signal, an automatic control mode that enables an entity outside the host vehicle to control the host vehicle using visible and/or audible cues; determining, e.g., via the vehicle controller, if at least one sensor in the network of sensing devices detects a visible/audible cue from the external entity and outputs a sensor signal indicative thereof; determining, e.g., via the vehicle controller responsive to receiving the sensor signal, if the detected visible/audible cue is any one of multiple preset valid commands; and transmitting, e.g., via the vehicle controller responsive to the detected visible/audible cue being a preset valid command, one or more command signals to one or more resident vehicle subsystems of the host vehicle to automate one or more vehicle operations corresponding to the preset valid command (e.g., reposition host vehicle, unlock host vehicle, lower vehicle window, disconnect vehicle battery pack, or perform any of the operations/commands associated with any mode, e.g., an obedience mode, discussed below, etc.).

Aspects of this disclosure are also directed to computer-readable media (CRM) for enabling external control of vehicles using visible and audible cues. In an example, a non-transitory CRM stores instructions that are executable by one or more processors of a vehicle controller. When executed by the processor(s), these instructions cause the controller to perform operations, including: receiving an automatic trigger signal indicating a host vehicle is in any one of multiple predefined automatic control trigger states; activating, responsive to receiving the automatic trigger signal, an automatic control mode enabling an external entity outside the host vehicle to control the host vehicle using a visible and/or audible cue; receiving, from a network of sensing devices of the host vehicle, a sensor signal indicating detection of the visible and/or audible cue from the external entity; determining if the detected visible and/or audible cue is a preset valid command; and transmitting, responsive to the detected visible and/or audible cue being the preset valid command, a command signal to a resident vehicle subsystem of the host vehicle to automate a vehicle operation corresponding to the preset valid command.

Additional aspects of this disclosure are directed to motor vehicles with intelligent control systems that provision external vehicle control using signs, gestures, verbal commands, etc. As used herein, the terms “vehicle” and “motor vehicle” may be used interchangeably and synonymously to include any relevant vehicle platform, such as passenger vehicles (ICE, HEV, FEV, fuel cell, fully or partially autonomous, etc.), commercial vehicles, industrial vehicles, tracked vehicles, off-road and all-terrain vehicles, motorcycles, farm equipment, watercraft, aircraft, etc. In an example, a motor vehicle includes a vehicle body with a passenger compartment, multiple road wheels mounted to the vehicle body (e.g., via corner modules coupled to a unibody or body-on-frame chassis), and other standard original equipment. A vehicle powertrain with a prime mover, such as an internal combustion engine (ICE) assembly and/or an electric traction motor, drives one or more of the road wheels to propel the vehicle. A network of sensing devices is distributed across the vehicle body and communicates sensor data to a resident or remote vehicle controller to help govern operation of the motor vehicle.

Continuing with the preceding discussion, the vehicle controller is programmed to receive an automatic trigger signal that indicates the motor vehicle is in any one of multiple predefined automatic control trigger states and, responsive to receiving this trigger signal, activate an automatic control mode that enables an entity outside the vehicle to control the vehicle using visible and/or audible cues. The controller then determines if the on-vehicle network of sensing devices detects a visible/audible cue from the external entity; if so, the controller responsively determines if the detected visible/audible cue is a preset valid command. Upon determining that the detected visible/audible cue is a valid command, the controller responsively commands one or more resident vehicle subsystems of the motor vehicle to automate one or more vehicle operations corresponding to the preset valid command.

Aspects of the present disclosure are directed to a method of controlling a autonomously operable vehicle. This method may comprise receiving, by the vehicle, a signal indicating that the vehicle is controllable in one or more of a number of operating modes. Each operating mode defines a unique set of actions that the vehicle may perform. This method may further comprise receiving, by the vehicle, a cue to operate the vehicle in one or more of the number of operating modes. This method may further comprise receiving, by the vehicle, a first command. This method may further comprise determining, by the vehicle, whether the first command is executable. This method may further comprise performing, by the vehicle, the first command after the vehicle determines that the first command is executable.

Aspects of the present disclosure are directed to a vehicle controller. The vehicle controller may be configured to receive a signal indicating that the vehicle is controllable in one or more of a number of operating modes, each operating mode defining a unique set of actions that the vehicle may perform. The vehicle controller further may be configured to receive a cue to operate the vehicle in one or more of the number of operating modes. The vehicle controller further may be configured to receive a first command. The vehicle controller further may be configured to determine whether the first command is executable. The vehicle controller further may be configured to perform the first command after the vehicle determines that the first command is executable.

Aspects of the present disclosure are directed to non-transitory, computer-readable media for storing instructions executable by one or more processors of a vehicle controller, causing the vehicle controller to perform certain operations. These operations may comprise receiving a signal indicating that the vehicle is controllable in one or more of a number of operating modes, each operating mode defining a unique set of actions that the vehicle may perform. These operations may further comprise receiving a cue to operate the vehicle in one or more of the number of operating modes. These operations may further comprise receiving a first command. These operations may comprise determining whether the first command is executable. These operations may further comprise performing the first command after the vehicle determines that the first command is executable.

For any of the disclosed vehicles, methods, and CRM, the vehicle controller may respond to the detected visible/audible cue not being a valid command by communicating with the network of sensing devices to receive a new sensor signal indicating detection of a new visible/audible cue from the external entity. Once detected, the controller determines if this new visible/audible cue is one of the predefined valid commands; if so, the controller responsively commands one or more of the resident vehicle subsystems to automate a vehicle operation corresponding to that valid command. Determining whether or not a visible/audible cue has been detected may include determining whether or not the network of sensing devices detects a visible and/or audible cue within a preset timeframe. In this instance, the vehicle controller may conclude a visible/audible cue is not detected when the sensors have not detected a visible/audible cue within the preset timeframe. Upon concluding that a visible/audible cue is not detected, the vehicle controller may responsively deactivate the automatic control mode.

For any of the disclosed vehicles, methods, and CRM, the vehicle controller, after commanding the resident vehicle subsystem(s) to automate the vehicle operation(s), may communicate with the sensing devices to receive a new sensor signal indicating detection of a new visible/audible cue from the external entity. The controller then determines if this new visible/audible cue is any one of multiple preset valid commands; if so, the controller may responsively command the resident vehicle subsystem(s) to automate one or more new vehicle operation(s) corresponding to the preset valid command. As another option, the vehicle controller may respond to not receiving an automatic trigger signal by receiving a manual trigger signal indicating the host vehicle received any one of multiple predefined manual trigger inputs. In this instance, the controller may respond to receiving the manual trigger signal by activating a manual control mode, distinct from the automatic control mode, that enables the external entity to control the host vehicle using visible and/or audible cues. For example, the automatic control mode may include a distinct (first) set of vehicle operations triggerable by visible/audible cue from an external entity, whereas the manual control mode includes another distinct (second) set of vehicle operations that are triggerable by visible/audible cues from the external entity. The manual trigger input may include the host vehicle detecting a predefined gesture or a preauthorized code and/or receiving in-vehicle approval from an occupant of the host vehicle.

For any of the disclosed vehicles, methods, and CRM, the vehicle controller may respond to not receiving an automatic or manual trigger signal by receiving a remote trigger signal that indicates the host vehicle received approval for external vehicle control from a remote vehicle command center (e.g., ONSTAR® or MYGMC®). In this instance, the vehicle controller may respond to receiving the remote trigger signal by activating a remote control mode that is distinct from both the manual and automatic control modes. For instance, the remote control mode may enable the command center to control the host vehicle using wirelessly transmitted control signals. The remote control mode may also enable an external entity to control the host vehicle using visible and/or audible cues. For example, the remote control mode may include a distinct (third) set of vehicle operations, which is different from the vehicle operation sets of the automatic and manual control modes, executable by the command center or triggerable by visible/audible cue from an external entity. The remote trigger signal may be generated in response to a telephone call between a remote vehicle command center and a cellular-enabled computing device of the external entity or a telematics unit in the host vehicle's passenger compartment.

For any of the disclosed vehicles, methods, and CRM, the vehicle controller may respond to activating the automatic control mode by activating a vehicle light system and/or a vehicle audio system of the host vehicle to output a predefined visible and/or audible confirmation indicating to the external entity that the automatic control mode is activated. As another option, the predefined automatic control trigger state may include the host vehicle being in a vehicle collision state (e.g., SOS call placed by telematics unit, airbag or pretensioner deployed, etc.), the host vehicle being in a vehicle incapacitated state (e.g., thermal runaway event detected), and/or the host vehicle being positioned within a predefined location (e.g., geopositional data indicates host within predefined geofence, manufacturer's warehouse, car dealer's lot, etc.).

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and exemplary modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a partially schematic, side-view illustration of an exemplary intelligent motor vehicle with a network of in-vehicle controllers, sensing devices, and communication devices for provisioning enhanced remote vehicle control by an external entity in accord with an embodiment of the present disclosure.

FIG. 2 is a flowchart illustrating an exemplary vehicle control algorithm for provisioning external operation of a vehicle using visible or audible cues, which may correspond to memory-stored instructions that are executable by a resident or remote controller, control-logic circuit, programmable control unit, or other integrated circuit (IC) device or network of devices in accord with an embodiment of the disclosed concepts.

FIG. 3 is a flowchart illustrating another exemplary vehicle control algorithm for provisioning external operation of a vehicle using cues, which may correspond to memory-stored instructions that are executable by a resident or remote controller, control-logic circuit, programmable control unit, or other integrated circuit (IC) device or network of devices in accord with an embodiment of the disclosed concepts.

FIG. 4 is a flowchart illustrating another exemplary vehicle control algorithm for provisioning external operation of a vehicle using cues, which may correspond to memory-stored instructions that are executable by a resident or remote controller, control-logic circuit, programmable control unit, or other integrated circuit (IC) device or network of devices in accord with an embodiment of the disclosed concepts.

FIG. 5 is an exemplary data set for affecting the operation of a vehicle control algorithm in accord with an embodiment of the disclosed concepts.

FIG. 6 is another exemplary data set for affecting the operation of a vehicle control algorithm in accord with an embodiment of the disclosed concepts.

FIG. 7 is another exemplary data set for affecting the operation of a vehicle control algorithm in accord with an embodiment of the disclosed concepts.

FIG. 8 is another exemplary data set for affecting the operation of a vehicle control algorithm in accord with an embodiment of the disclosed concepts.

FIG. 9 is another exemplary data set for affecting the operation of a vehicle control algorithm in accord with an embodiment of the disclosed concepts.

The present disclosure is amenable to various modifications and alternative forms, and some exemplary embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Exemplary embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference or otherwise. Moreover, recitation of “first”, “second”, “third”, etc., in the specification or claims is not used to establish a serial or numerical limitation; rather, these designations may be used for ease of reference to similar features in the specification and drawings and to demarcate between similar elements in the claims.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein in the sense of “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

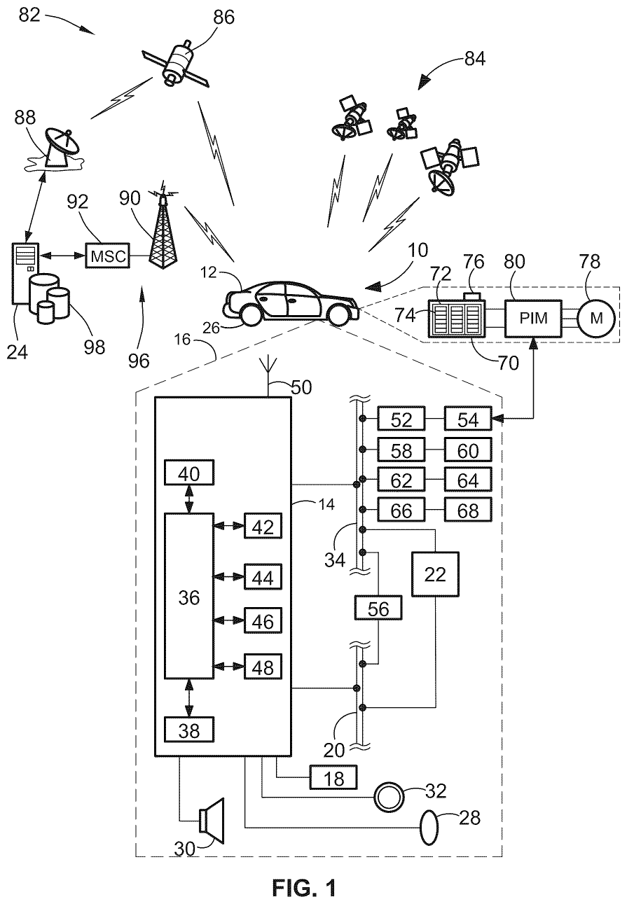

Referring now to the drawings, wherein like reference numbers refer to like features throughout the several views, there is shown, in FIG. 1, an exemplary motor vehicle, which is designated generally at 10 and portrayed herein for purposes of discussion as a sedan-style, electric-drive automobile. The illustrated automobile 10—also referred to herein as “motor vehicle” or “vehicle” for short—is merely an exemplary application with which aspects of this disclosure may be practiced. In the same vein, incorporation of the present concepts into the illustrated wireless communications network for cellular and mesh-enabled “talking” cars should also be appreciated as a non-limiting implementation of disclosed features. As such, it will be understood that novel aspects and features of this disclosure may be applied to other wireless network architectures, implemented for a myriad of different triggering events, and incorporated into any logically relevant type of vehicle. Moreover, only select components of the motor vehicles and intelligent vehicle control systems are shown and described in additional detail herein. Nevertheless, the vehicles and systems discussed below may include numerous additional and alternative features, and other available peripheral components, for carrying out the various methods and functions of this disclosure.

The exemplary vehicle 10 of FIG. 1 is originally equipped with a vehicle telecommunications and information (“telematics”) unit 14 that wirelessly communicates, e.g., via non-limiting examples of cell towers, base stations, mobile switching centers, satellite service, etc., with a remotely located back-office (BO) cloud computing host service 24 (e.g., ONSTAR®). Some of the other vehicle hardware components 16 shown generally in FIG. 1 include, as non-limiting examples, an electronic video display device 18, a microphone 28, audio speakers 30, and assorted user input controls 32 (e.g., buttons, knobs, switches, touchpads, joysticks, touchscreens, etc.). These hardware components 16 function, in part, as a human-machine interface (HMI) that enables a user to communicate with the telematics unit 14 and other components resident to and remote from the vehicle 10. Microphone 28, for instance, provides occupants with a means to input verbal or other auditory commands; the vehicle 10 employs an embedded voice-processing unit utilizing audio filtering, editing, and analysis modules to convert the inputs to signals. Conversely, the speakers 30 provide audible output to a vehicle occupant and may be either a stand-alone speaker dedicated for use with the telematics unit 14 or may be part of an audio system 22. The audio system 22 is operatively connected to a network connection interface 34 and an audio bus 20 to receive analog information, rendering it as sound, via one or more speaker components. Such components may be located inside or outside of the vehicle and may be capable of interpreting or providing signals outside or inside of the vehicle.

Communicatively coupled to the telematics unit 14 is a network connection interface 34, suitable examples of which include twisted pair/fiber optic Ethernet switches, parallel/serial communications buses, local area network (LAN) interfaces, controller area network (CAN) interfaces, and the like. The network connection interface 34 enables the vehicle hardware 16 to send and receive signals with one another and with various systems both onboard and off-board the vehicle body 12. This allows the vehicle 10 to perform assorted vehicle functions, such as modulating powertrain output, activating friction or regenerative brakes, controlling vehicle steering, managing operation of a traction battery pack, controlling vehicle windows, doors, and lock, and any other function that can be automated. For instance, telematics unit 14 may exchange signals with a Powertrain Control Module (PCM) 52, an Advanced Driver Assistance System (ADAS) module 54, an Electronic Battery Control Module (EBCM) 56, a Steering Control Module (SCM) 58, a Brake System Control Module (BSCM) 60, and assorted other vehicle ECUs, such as a transmission control module (TCM), engine control module (ECM), Sensor System Interface Module (SSIM), or any other module capable of controlling a function associated with the vehicle, etc.

With continuing reference to FIG. 1, telematics unit 14 is an onboard computing device that provides a mixture of services, both individually and through its communication with other networked devices. This telematics unit 14 is generally composed of one or more processors 40, each of which may be embodied as a discrete microprocessor, an application specific integrated circuit (ASIC), or a dedicated control module. Vehicle 10 may offer centralized vehicle control via a central processing unit (CPU) 36 that is operatively coupled to a real-time clock (RTC) 42 and one or more electronic memory devices 38, each of which may take on the form of a CD-ROM, magnetic disk, IC device, a solid-state drive (SSD) memory, a hard-disk drive (HDD) memory, flash memory, semiconductor memory (e.g., various types of RAM or ROM), etc.

Long-range communication (LRC) capabilities with off-board devices may be provided via one or more or all of a cellular chipset, an ultra-high frequency radio transceiver, a navigation and location component (e.g., global positioning system (GPS) transceiver), and/or a wireless modem, all of which are collectively represented at 44. Short-range communication (SRC) may be provided via a close-range communication device 46 (e.g., a BLUETOOTH® unit or near field communications (NFC) transceiver), UWB comm device, a dedicated short-range communications (DSRC) component 48, and/or a dual antenna 50. The communications devices described above may provision data exchanges as part of a periodic broadcast in a vehicle-to-vehicle (V2V) communications network or a vehicle-to-everything (V2X) communications network, e.g., Vehicle-to-Infrastructure (V2I), Vehicle-to-Pedestrian (V2P), Vehicle-to-Device (V2D), etc. It is envisioned that the vehicle 10 may be implemented without one or more of the above listed components or, optionally, may include additional components and functionality as desired for a particular end use.

CPU 36 receives sensor data from one or more sensing devices that use, for example, photo detection, radar, laser, ultrasonic, optical, infrared, or other suitable technology, including short range communications technologies (e.g., DSRC or BLUETOOTH® or BLE®) or Ultra-Wide Band (UWB) radio technologies, e.g., for executing an automated vehicle operation or a vehicle navigation service. In accord with the illustrated example, the automobile 10 may be equipped with one or more digital cameras 62, one or more range sensors 64, one or more vehicle speed sensors 66, one or more vehicle dynamics sensors 68, and any requisite filtering, classification, fusion, and analysis hardware and software for processing raw sensor data. The type, placement, number, and interoperability of the distributed array of in-vehicle sensors may be adapted, singly or collectively, to a given vehicle platform for achieving a desired level of automation and concomitant autonomous vehicle operation.

To propel the motor vehicle 10, an electrified powertrain is operable to generate and deliver tractive torque to one or more of the vehicle's drive wheels 26. The vehicle's electrified powertrain is generally represented in FIG. 1 by an electric traction motor 78 that is operatively connected to a rechargeable energy storage system (RESS), which may be in the nature of a chassis-mounted traction battery pack 70. The traction battery pack 70 may be generally composed of one or more battery modules 72 each containing a group of electrochemical battery cells 74, such as lithium ion, lithium polymer, or nickel metal hydride battery cells. Traction motor/generator (M) unit 78 draws electrical power from and, optionally, delivers electrical power to the battery pack 70. A power inverter module (PIM) 80 electrically connects the battery pack 70 to the motor/generator unit(s) 78 and modulates the transfer of electrical current therebetween. The battery pack 70 may be configured such that module management, cell sensing, and module-to-module or module-to-host communications functionality is integrated directly into each module 72 and performed wirelessly via a wireless-enabled cell monitoring unit (CMU) 76. This electrified powertrain is an example and other powertrains may be used such as traditional internal combustion engines, hybrid systems, diesel engines, turbines, etc.

Also shown in FIG. 1 is a mobile vehicle communications (MVC) system 82 that enables wireless communications between remotely located computing nodes and one or more motor vehicles 10. MVC system 82 is represented herein by a constellation of GPS satellites 84, a wireless services satellite 86, an uplink transmitting station 88, a cellular (cell) transceiver tower 90, and a mobile switching center (MSC) 92. Other types of communication systems may be used including microwave, laser, other radio systems, etc. A host vehicle's GPS transceiver 44 may exchange radio signals with the GPS satellites 84 to derive real-time or near real-time geopositional and time data for the vehicle 10, which may be used to provide navigation and other related services to vehicle occupants. Wireless services satellite 86, through cooperative operation with the uplink transmitting station 88, provisions unidirectional and bidirectional communications with the vehicle 10, such as satellite radio and media services (e.g., music, news, videos, etc.) and satellite telephony services (e.g., to contact a remote vehicle command center). While shown with a single vehicle 10 communicating with multiple GPS satellites 84, a single wireless services satellite 86, a single uplink station 88, a single cell tower 90, and a single MSC 92, MVC system 82 may incorporate any number and combination of the foregoing elements as well as other available and hereafter developed communications hardware.

The MVC system 82 may operate within a cellular communications system 96, which is represented in FIG. 1 by one or more cell towers 90, one or more mobile switching centers 92, as well as any other networking components needed to link the cellular communications system 96 with assorted end nodes (e.g., BO host service 24). Each cell tower 90 may be equipped with a respective set of sending and receiving antennas for exchanging radio signals with vehicles 10. Base stations of the different cell towers may be connected to the MSC 92 either directly or via intermediary equipment, such as a base station controller (not shown). The cellular communications system 96 may implement any suitable communications technology, including earlier cellular protocols, such as cellular digital packet data (CDPD) 2G technologies, or contemporary cellular protocols, such as 4G-LTE of 5G-Advanced technologies. Vehicle telematics unit 14 may function as a cellular-enabled mobile component that is registered with a cellular carrier to transmit network data packets to and from the cellular communications system 96. It should be appreciated that the system 96 may take on innumerable tower/station/MSC arrangements, including co-location of a base station and a cell tower at the same site, remotely locating base stations and cell towers from one another, a single base station servicing a single cell tower, a single cell servicing multiple cell towers, and coupling multiple base stations to a single MSC, to name but a few possible arrangements.

In accord with disclosed concepts, it is oftentimes desirable to enable operation of a host vehicle by an individual located outside of the vehicle's passenger compartment, or a combination of inside and/or outside the vehicle, without the need for preauthorization of that individual or a wireless-enabled handheld computing device to input vehicle control commands. Discussed below are intelligent vehicle control systems and control logic for provisioning device-less external command and control by third parties, e.g., in predefined urgent situations in which predicting the need for control and authorizing users ahead of time is not practical. Urgent situations may unexpectedly necessitate a person to command a vehicle from outside the vehicle using visible or audible commands. Some non-limiting examples of such “urgent” situations may include enabling law enforcement, armed services, paramedics, or any first responder to: reposition a vehicle during a riot or crowd control incident; access a passenger compartment or move a vehicle over to a roadway shoulder after a collision event; relocate a vehicle off railroad tracks, out of intersections, etc., to eliminate dangerous situations; move a vehicle with an officer to provide active protection and cover; move a vehicle to an open area when it is on fire or has the potential for one, etc. Disclosed vehicle control modes may also be utilized in non-urgent situations, such as by original equipment manufacturer (OEM) staff after vehicle roll-off from the production line (“pre-shipping mode”), by fleet staff during rental, delivery, or maintenance, by government staff or sales staff within a designated parking lot/garage or virtual geofence, etc. While not per se limited, aspects of this disclosure may be particularly relevant to Software Defined Vehicles (SDV) that manage vehicle operations, provision new vehicle functionality, and enable new in-vehicle user features primarily or entirely through software. SDVs are highly mechatronic intelligent devices that offer increased flexibility, customization, and remote upgradeability over their conventional counterparts.

By and large, many automobiles are not able to receive or approve commands from an external entity without some form of electronic device, wireless connectivity, and predefined assignment or authentication of the entity. Disclosed systems and methods reduce/eliminate these obstacles by using on-vehicle sensors, available vehicle condition and state data, contextual assessments, etc., to dynamically evaluate and enable an external entity to control the host vehicle. For instance, an intelligent vehicle control system may monitor for Obedience Mode triggers and, once received, attempt to detect an event that permits automatic approval. Some such examples include vehicle controller confirmation of: an automated collision event call to a BO host vehicle service/vehicle command center; an airbag/pretensioner/near deploy/low-level deployment event; a thermal runaway propagation (TRP) event; a remote vehicle slowdown; geopositional data indicating the vehicle is within a defined geofenced area; or the host vehicle being set in a specific vehicle operating mode (e.g., manufacturing mode, fleet override mode, long-term remote approval, etc.).

Upon corroborating the existence of a valid triggering event, the vehicle system automatically enables external control to be taken by a third party outside the vehicle and indicates to the external party the mode being activated with visual and audible indications. The vehicle control system collaborates with an on-vehicle network of sensors, such as cameras, motion sensors, and microphones, to receive visible or audible cues, such as predefined gestures (e.g., “secret” combinations of hand motions), verbal instructions (e.g., preset passwords or designated words), preassigned QR codes (e.g., dynamically downloaded from a command center), or in-vehicle approvals through buttons or displays. Under predefined conditions, the vehicle control system may receive remote approval from a command center to enable external control. Remote Control mode may be initiated in various ways, such as the host vehicle contacting a command center agent for approval, the command center contacting the host vehicle to initiate approval, a third party contacting the command center and providing proof of ownership or authority, or a command center agent contacting the third party, e.g., after attempting to enter manual mode but exceeding a number of invalid attempts. Once an external control mode is entered, the host vehicle may respond to valid commands and reject invalid commands (e.g., if unrecognized or deemed unsafe or illegal). The host vehicle may output visible/audible notification to the user for invalid commands. The system may time out (e.g., remotely or by default) if no further commands are received or a threshold number of invalid commands are received; the system will automatically notify the command center and exit the control mode. A general intent of at least some disclosed concepts is to provide controlled delegation of commanding authority of a vehicle to a human or non-human operator irrespective of their state of occupancy of the vehicle.

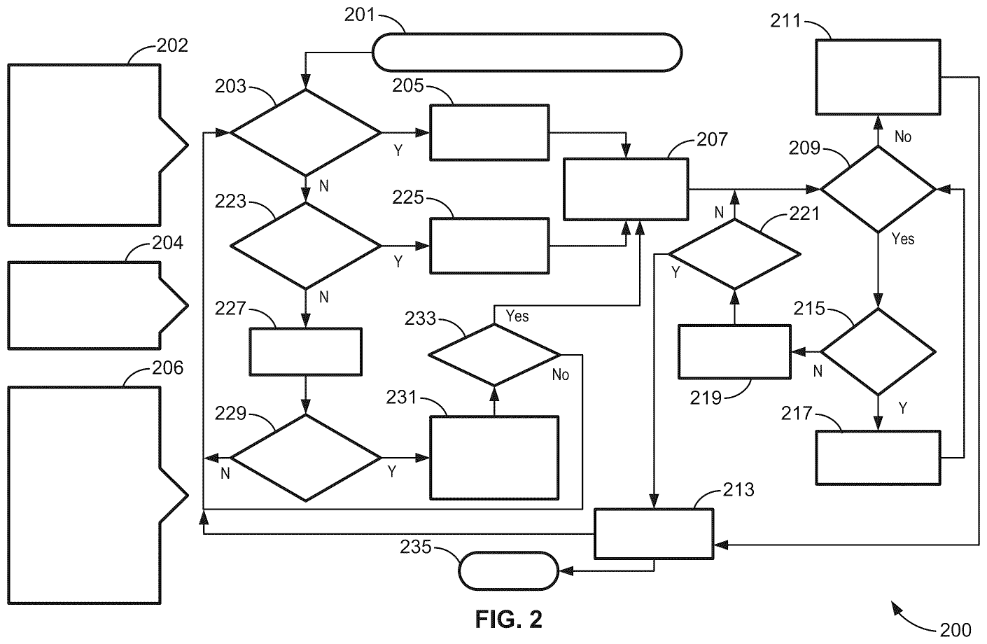

With reference next to the flow chart of FIG. 2, an improved method or control strategy for provisioning external control of a motor vehicle, such as automobile 10 of FIG. 1, via an entity outside of yet proximal to the vehicle is generally described at 200 in accordance with an embodiment of the present disclosure. Some or all of the operations illustrated in FIG. 2, and described in further detail below, provide an example of an algorithm that corresponds to non-transitory, processor-executable instructions that are stored, for example, in main or auxiliary or remote memory (e.g., memory device 38 and/or database 98 of FIG. 1), and executed, for example, by an electronic controller, processing unit, dedicated control module, logic circuit, or other module or device or network of modules/devices (e.g., CPU 36 and/or cloud computing service 24 of FIG. 1), to perform any or all of the above and below described functions associated with an embodiment of the disclosed concepts. It should be recognized that the order of execution of the illustrated operation blocks may be changed, additional operation blocks may be added, and some of the herein described operations may be modified, combined, or eliminated.

Method 200 begins at START terminal block 201 of FIG. 2 with memory-stored, processor-executable instructions for a programmable controller or control module or similarly suitable processor to call up an initialization procedure for an Obedience Mode protocol. This routine may be executed in real-time, near real-time, continuously, systematically, sporadically, and/or at regular intervals, for example, each 10 or 100 milliseconds during operation of the motor vehicle 10. As yet another option, terminal block 201 may initialize responsive to a user command prompt (e.g., via telematics input controls 32), a resident vehicle controller prompt (e.g., via CPU 36), or a broadcast prompt signal received from an “off-board” centralized vehicle services system (e.g., BO cloud computing service 24), each of which may be a signal or cue to the vehicle that is controllable in one or more mode (obedience, operating, etc.). By way of example, and not limitation, method 200 may be initialized by a host vehicle controller in response to monitoring for and detecting any one of an assortment of obedience mode command triggers. Non-limiting examples of potential command triggers are enumerated above and are illustrated in FIG. 2 in Automatic Trigger data file 202, Manual Trigger data file 204, and Remote Trigger data file 206, each of which is described in further detail below. Upon completion of some or all of the control operations presented in FIG. 2, the method 200 may advance to END terminal block 235 and temporarily terminate or, optionally, may loop back to terminal block 201 or decision block 203 and run in a continuous loop.

Advancing from terminal block 201 to AUTOMATIC TRIGGER decision block 203, the method 200 determines whether or not an automatic trigger is received that automatically enables external control of the host vehicle using visible/audible commands. Memory-stored Automatic Trigger data file 202 denotes that an automatic trigger may include a vehicle controller (e.g., telematics unit CPU 36) receiving one or more sensor signals indicating: (1) an SOS/collision call was made to/from the host vehicle; (2) an airbag/seatbelt pretensioner/near deployment event was sensed within the host vehicle; (3) a thermal runaway propagation event is predicted or was detected within the host vehicle's RESS; (4) a real-time or near real-time location of the host vehicle is within a designated geofence; and/or (5) the host vehicle operating mode is set to a “pre-sale” or “pre-shipping” mode (e.g., in OEM, dealer, or rental lot/garage/warehouse/etc.). It should be appreciated that the herein described automatic, manual, and/or remote triggers may include greater, fewer, or alternative triggers than those presented.

Upon receiving any one of the predefined automatic triggers (Block 203=YES), method 200 proceeds to AUTOMATIC CONTROL MODE predefined process block 205 and activates an automatic control mode that enables an entity outside of the host vehicle to control predetermined operations of the vehicle using one or more visible and/or audible cues. The automatic control mode may enable a restricted (first) set of vehicle operations, each of which may be elicited by a respective visible or audible cue received from the external entity. Because preauthorization of the external entity may not be mandatory due to the exigent nature of an automatic control trigger, the memory-stored set of vehicle operations associated therewith may be restricted to just those vehicle control operations deemed necessary to protect the host vehicle and its occupants. It is envisioned that the host vehicle may solicit commands from or provide command options to the external entity.

Upon activation of an external control mode, method 200 may execute EXTERNAL CONTROL CONFIRMATION process block 207 and provide visual/audible confirmation to the external entity that external control is activated and the host vehicle is ready to receive commands. For instance, telematics unit CPU 36 may activate automatic control mode (Block 205), manual control mode (Block 225), or remote control mode (Block 231) and concomitantly command a vehicle subsystem of the host vehicle to output a predefined visible and/or audible confirmation indicating an external control mode is now active (Block 207). To this end, an activation signal may be transmitted to a host vehicle light system (e.g., front turn signals, headlamps, etc.) to generate a predefined light pattern (e.g., headlamps flash twice) or to a host vehicle audio system (e.g., car horn or audio system) to generate a predefined sound pattern (e.g., horn honks twice) or verbal confirmation (passenger cabin speakers output “EXTERNAL CONTROL ACTIVATED!”).

With continuing reference to FIG. 2, method 200 advances from process block 207 to COMMAND DETECTION decision block 209 to determine whether or not a control command is received by the host vehicle from the external entity. In a non-limiting example, the vehicle controller (e.g., CPU 36 of FIG. 1) may communicate with an on-vehicle network of sensing devices (e.g., microphone 28, digital camera(s) 62, range sensor(s) 64, etc.) to detect any visible and/or audible cues input by the external entity. If the external entity does not input a visible/audible cue or they do so in a manner or from a location that renders the cue undetectable by the host vehicle, decision block 209 may conclude that a control command was not received. As a further option, activation of an external control mode (Blocks 205, 225 or 231) may commence a timer (e.g., using real-time clock (RTC) 42); decision block 209 may then monitor this timer to determine whether or not the on-vehicle network of sensing devices detects a visible/audible cue within a preset timeframe (e.g., maximum two (2) minute window). In this example, the vehicle controller may respond to the non-detection of a visible/audible cue within the preset timeframe by concluding that a visible or audible cue was not received. If no command is received (Block 209=NO), method 200 executes NO COMMAND TIMEOUT block 211 and sets a flag in cache memory that neither an audible nor a visible command was detected, and then executes EXTERNAL CONTROL DISABLED predefined process block 213 and disables the previously activated external control mode.

If a sensor-detectable command is received from the external entity (Block 209=YES), method 200 responsively executes VALID COMMAND decision block 215 to determine whether or not the detected visible/audible cue is any one of multiple preset valid commands. As an example, the digital camera(s) 62 may detect a first responder signaling with their right arm and hand for the host vehicle to move to the shoulder of the road; sensor signals indicative of these hand gestures are transmitted to the CPU 36 for processing and evaluation. The CPU 36 may compare the detected hand gesture to a preset list of valid commands—the restricted set of vehicle operations—which may be enumerated in a memory-stored lookup table assigned to the automatic control mode. If the detected hand gesture corresponds to one of the valid commands listed in the vehicle operation set, the CPU 36 concludes that a valid command was in fact received (Block 215=YES). Consequently, the method 200 automatically triggers EXECUTE COMMAND process block 217 to transmit one or more command signals to a necessary resident vehicle subsystem or subsystems of the host vehicle to automate the vehicle operation that corresponds to the preset valid command associated with the detected cue. At this juncture, the method 200 may loop back to decision block 209 and monitor for additional command inputs; otherwise, the method 200 may disable the external control mode at predefined process block 213 and then temporarily terminate at terminal block 235.

Upon determining that the detected external command cue is not recognized as one of the preset valid commands (Block 215=NO), method 200 responsively effects COMMAND FAILURE NOTIFICATION process block 219. Process block 219 may provide computer-readable instructions that cause the host vehicle to provide a predetermined visual/audible output to the external entity that indicates that the received command is an invalid command or a rejected command. It may be desirable that the visual/audible outputs implemented at process block 219 (e.g., single honk of horn or single flash of both front turn signals) be distinct from the visual/audible outputs implemented at process block 207 (e.g., double honk of horn or double flash of front headlamps). At this juncture, the method 200 may loop back to decision block 209—and any of the situation-pertinent processes blocks downstream therefrom—at which the vehicle controller communicates with the networked sensing devices to receive additional (new) sensor signals indicating detection of additional (new) cues from the external entity.

Before looping back to decision block 209 from process block 219, the method 200 may optionally execute FAILED THRESHOLD decision block 221 to determine whether or not the external entity has exceeded a predefined maximum number of attempts at inputting a valid command. By way of non-limiting example, activation of an external control mode at process blocks 205, 225, or 231 may concurrently initialize an invalid command counter that is built into the control algorithm. After automatic control mode is enabled at process block 205, for example, the external entity may be afforded five (5) attempts to enter a valid command before the system disengages automatic control. Optionally, a distinct number of attempts may be set in relation to severity of the situation or the purpose of vehicle control (e.g., afforded more attempts during an urgent situation than during a non-urgent situation). It is also envisioned that the number of attempts may be dynamically adjusted by the vehicle control system or BO host vehicle service based on vehicle sensor feedback, contextual data, vehicle state, remote user identify, etc. Upon determining that the external entity has exceeded its allotted maximum number of command attempts (Block 221=YES), method 200 responsively deactivates the external control mode at block 213. Conversely, if the entity has not exceeded their allotted maximum number of command attempts (Block 221=NO), method 200 loops back through process block 209.

Turning back to process block 203 of FIG. 2, method 200 may respond to not receiving a predefined automatic trigger (Block 203=NO) by executing MANUAL TRIGGER decision block 223 to determine whether or not a manual trigger is received to manually enable external control of the host vehicle. Memory-stored Manual Trigger data file 204 denotes that a manual trigger may include a vehicle controller (e.g., telematics unit CPU 36) receiving one or more sensor signals indicating: (1) detection of a predefined “specialized” gesture or gesture sequence; (2) scanning of a quick-reference (QR) code, barcode, data matrix code, NFC or RFID fob, or other scannable or detectable hand-held article assigned to a specific level of access; and/or (3) receipt of in-vehicle approval from a driver or occupant of the host vehicle. Other examples of potential “manual” triggers may include the vehicle controller and on-vehicle sensor network cooperatively identifying a recognized user pattern (e.g., EMS or law enforcement uniform, helmet, or badge), rank, special badge, biometric characteristics, etc.

Upon receiving at least one of the predefined manual triggers (Block 223=YES), method 200 proceeds to MANUAL CONTROL MODE predefined process block 225 and activates a manual control mode that enables an entity outside of the host vehicle to control predetermined operations of the vehicle using one or more visible and/or audible cues. The manual control mode may enable a less restricted (second) set of vehicle operations, each of which may be elicited by a respective visible or audible cue received from the external entity. Because some form of preauthorization of the external entity is requested to enable manual control, the memory-stored set of vehicle operations associated therewith may afford more vehicle control operations than those provided for automatic control. Comparable to the automatic control mode, however, the number and type of vehicle operations available during external vehicle control may be increased or decreased based on situation-specific data (e.g., the level of preauthorization provided).

If neither an automatic trigger nor a manual trigger is received (Block 203=NO & & Block 223=NO), method 200 responsively executes TRIGGER FAILURE NOTIFICATION process block 227 and thereby causes the host vehicle to provide a predetermined visual/audible output that is designed to notify the external entity that a valid trigger was not received or a received trigger is deemed invalid. It may be desirable that the visual/audible outputs implemented at process block 219 (e.g., single honk of horn or single flash of both front turn signals) be distinct from the visual/audible outputs implemented at process block 227 (e.g., three quick honks of horn or flashes of headlamps) to help ensure that the external entity is able to demarcate between these notifications.

Method 200 of FIG. 2 continues from process block 227 to REMOTE TRIGGER decision block 229 to determine whether or not a remote trigger is received to remotely enable external control of the host vehicle. Memory-stored Remote Trigger data file 206 denotes that a remote control request trigger may include a vehicle controller (e.g., telematics unit CPU 36) receiving one or more sensor signals indicating: (1) a call was placed by an occupant or controller of a host vehicle to a BO host vehicle service (also referred to herein as “vehicle command center”); (2) a call was placed by an external entity or other third party to the BO host vehicle service; (3) a call was received by the host vehicle from the BO host vehicle service; and/or (4) the received manual triggers were recognized but not approved and authorization for external control is being requested. In general, remote control approval may necessitate some form of “off-board” permission process or the centralized command center taking control of the host vehicle or authorizing external control for a local third party. Upon determining that the remote control attempt was unsuccessful (Block 229=NO), method 200 may loop from decision block 229 back to terminal block 201 or decision block 203 or may temporarily end at terminal block 235.

After receiving at least one remote control trigger (Block 229=YES), method 200 proceeds to REMOTE CONTROL MODE predefined process block 231 and activates a remote control mode in response to remote approval to enable a vehicle command center and/or an entity outside of the host vehicle to control predetermined operations of the vehicle. The remote control mode may enable an expanded (third) set of vehicle operations, each of which may be elicited by a respective visible or audible cue received from the external entity. Because enhanced preauthorization of the external entity is requested to enable remote control, the memory-stored set of vehicle operations associated therewith may afford more vehicle control operations than those provided for manual control mode. In addition to or as an alternative for authorizing control of an external entity, remote control of the host vehicle may be subsumed by the vehicle command center. For example, method 200 may execute REMOTE CONTROL APPROVED decision block 233 to determine whether or not an external entity may take over vehicle control using visible/audible cues. If so (Block 233=YES), method 200 advances to process block 207; otherwise, the method 200 may respond to a denial of remote control (Block 233=NO) by disabling external control mode at process block 213.

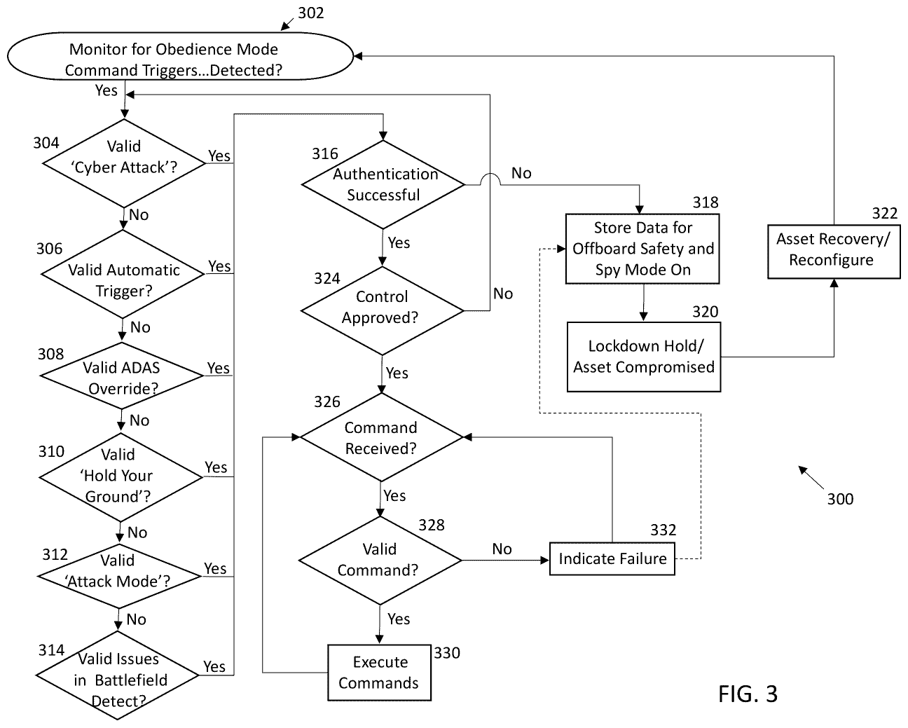

With reference next to the flow chart of FIG. 3, another embodiment of an improved method or control strategy for provisioning external control of an autonomously operable vehicle, such as automobile 10 of FIG. 1, via an entity outside of yet proximal to the vehicle is generally described at 300 in accordance with some embodiments of the present disclosure. Some or all of the operations illustrated in FIG. 3 and described in further detail below may provide an example of an algorithm that corresponds to non-transitory, processor-executable instructions that are stored, for example, in main or auxiliary or remote memory (e.g., memory device 38 and/or database 98 of FIG. 1), and executed, for example, by an electronic controller, processing unit, dedicated control module, logic circuit, or other module or device or network of modules/devices (e.g., CPU 36 and/or cloud computing service 24 of FIG. 1), to perform any or all of the above and below described functions associated with the disclosed concepts. It should be recognized that the order of execution of the illustrated operation blocks may be changed, additional operation blocks may be added, and some of the herein described operations may be modified, combined, or eliminated.

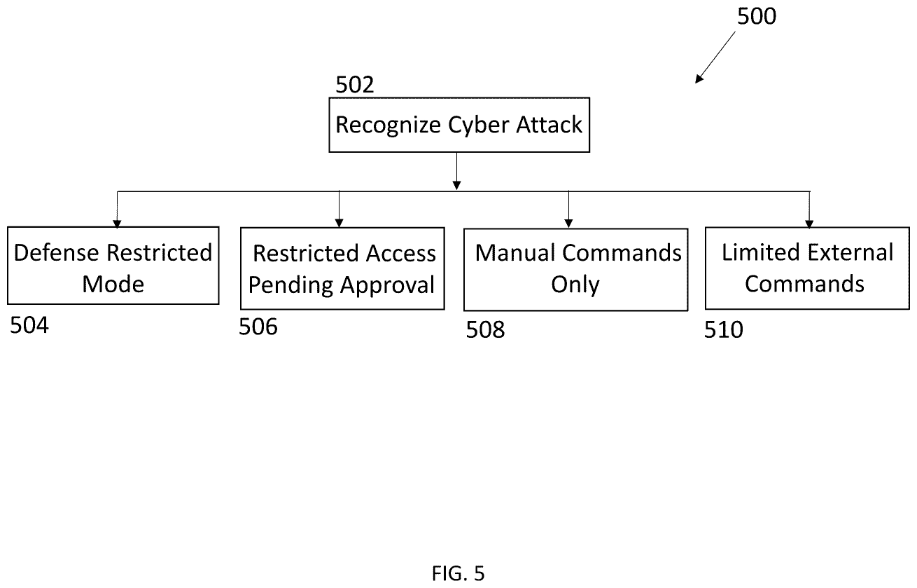

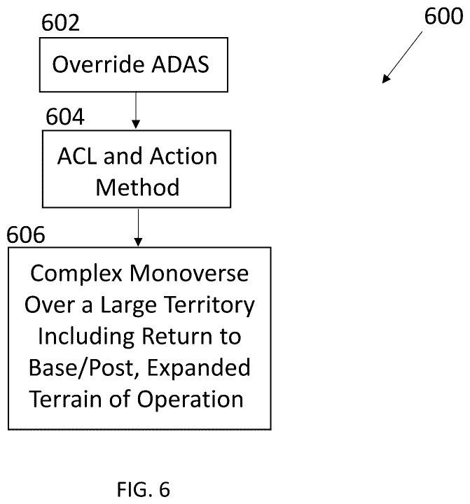

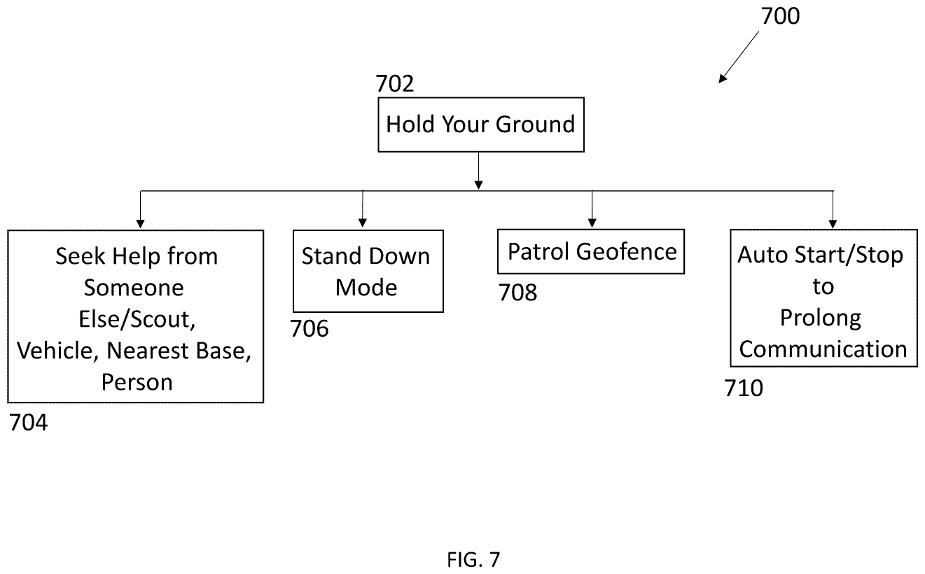

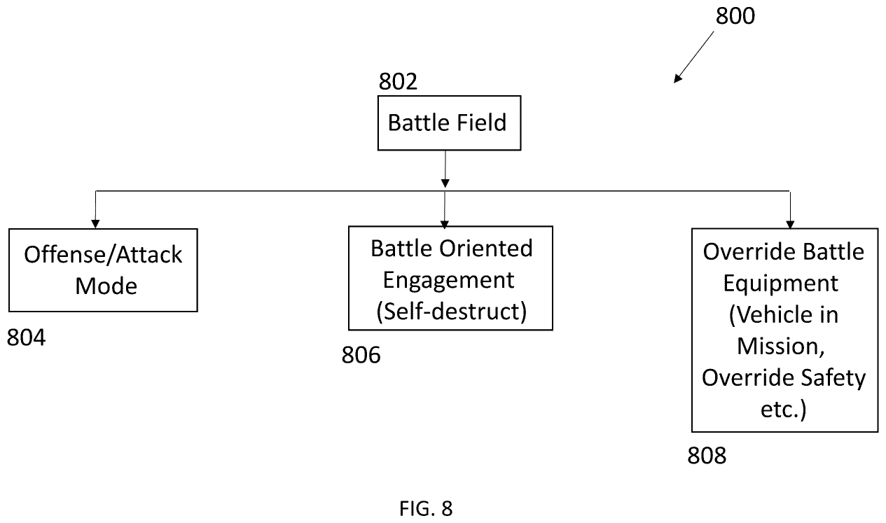

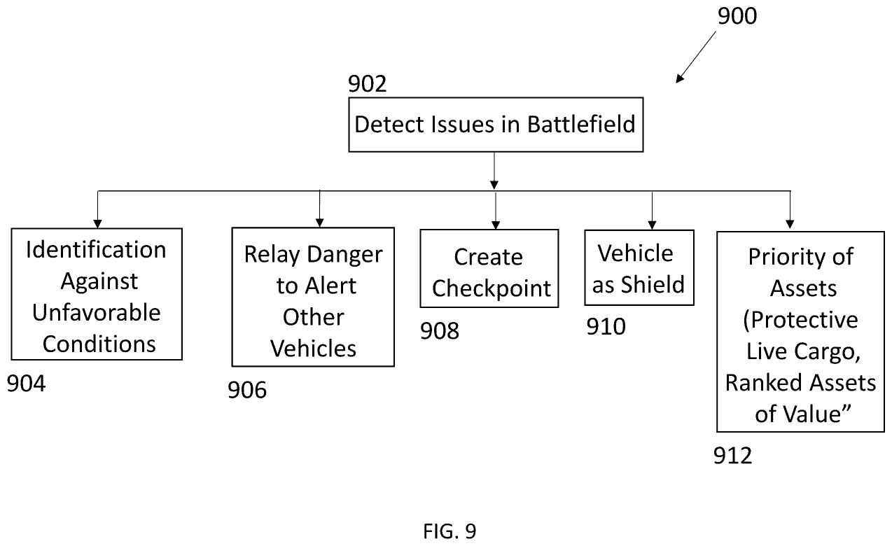

Method 300 begins at block 302 of FIG. 3 with memory-stored, processor-executable instructions for a programmable controller or control module or similarly suitable processor to call up an initialization procedure for an Obedience Mode, or operating mode, upon receiving an appropriate signal indicating that the vehicle is controllable in such a mode. Block 302 may be similar to and comprise features described above for block 201 of FIG. 2. Block 302 may comprise the continuous monitoring for command triggers that will start or set a vehicle in an obedience mode. As similarly described with respect to FIG. 2, block 302 may initialize responsive to a user command prompt (e.g., via telematics input controls 32, from inside or outside a vehicle), a resident vehicle controller prompt (e.g., via CPU 36), or a broadcast prompt signal received from an “off-board” centralized vehicle services system (e.g., BO cloud computing service 24, or a central command and control location), or a signal. By way of example, and not limitation, method 300 may be initialized by a host vehicle controller in response to monitoring for and detecting any one of an assortment of obedience mode command triggers, or signals, which may themselves be commands for the vehicle to perform certain actions within one or more of those operating modes. In addition to the non-limiting examples of potential command triggers are enumerated above and illustrated in FIG. 2, further triggers may include the Cyber Attack data (FIG. 5), an Automatic Trigger (which may be similar to Automatic trigger data 202), Override ADAS data (FIG. 6), Hold Your Ground Data (FIG. 7), Battlefield (or attack) Data (FIG. 8), and Battlefield Issue Detection Data (FIG. 9), each of which is further described below. Upon completion of some or all of the control operations presented in FIG. 3, the method 300 may end, similar to the description of the END terminal block 235 of FIG. 2, temporarily terminate or, optionally, may loop back to block 301, running in a continuous loop. External control may be removed in method 300 according to block 213 as described above for FIG. 2.

In some embodiments, the signal indicating that the vehicle is controllable the one or more operating modes is received from a remote back office, control center, or command center that may control and/or authenticate the vehicle operating in such modes.

Various obedience or operating modes may be activated and implement by method 300, including both those listed in blocks 304, 306, 308, 310, 312, 314, and those operating modes listed in FIG. 2 (e.g., blocks 203, 223, and 229). The activation of any of these modes (e.g., a “yes” decision at the foregoing blocks) and operations (e.g., commands indicated by a cue) performable within these modes may be controlled by set of unique data for each of these modes. Any of these data may be stored within the controllable vehicle or may be accessed from a remote location. For example, in accordance with some embodiments, Cyber Attack data 500 as shown in FIG. 5 may affect or determine the operation of a vehicle. Upon the recognition of a cyber-attack as dictated by data 502, the vehicle actions may be limited to set of actions, which may be unique to a cyber-attack obedience mode. For example, data 504 may restrict the actions of the vehicle to, e.g., defensive actions only. In more detail, if a vehicle is, e.g., a military vehicle capable of both offensive and defensive actions, the vehicle may be limited to defensive actions only if it recognized that the vehicle is potentially comprised, or that attempts are being made to compromise it, via a cyber-attack. Such restrictions in operations as a result of a cyber-attack may also be applied to commands occurring in other obedience modes. In other examples, data 504 may create a mode of operation that more generally limits vehicle actions and/or requires additional authentication during cyber-attacks, including actions of other obedience mdoes. An access control list may govern access to this mode, with action methods enforcing restricted actions (e.g., commands). Examples of restricted action may include limiting offensive functionality, limiting actions to positioning commands (e.g., retreating to a secure location), or limiting the vehicle to providing shielding capabilities to protect personnel or equipment.

Access control lists effecting any of the obedience modes may utilize any of a variety of factors to determine whether an entity has access to the requested commands of a vehicle. Such factors may include uniforms, rank, insignia, unit patches, country patches worn, short-range emissions, radio or otherwise, predesignated symbols worn or shown by the entity requesting access, nametags, facial recognition or other biometric markers, infrared markers, in addition to other factors known of a person of ordinary skill in the art.

As another example, block 506 may provide data providing for more restricted access and/or additional approvals required in order to execute certain commands. For example, while a vehicle may be controllable by providing only an external cue, a vehicle that is potentially comprised may require additional cues or authentication prior to executing a command. For example, an operator may interface with the vehicle to provide biometric data, or may use an electronic device providing an additional authentication factor, before the vehicle executes a command. An access control list may manage access to certain actions/commands, and action methods may be executed pending approval from an authorized source inside the vehicle before execution and/or from another external entity via a secured link.

Data 508 may limit the vehicle to only manual commands, such as those described above in FIG. 2 at blocks 204 and 223. This may require direct connection with the vehicle rather than, e.g., using wireless commands (such as short range wireless, visual, audio) to direct the vehicle. Direct connection may be achievable on an external surface of the vehicle, or may be required internally which, again, may require additional authentication factors, such as a key. Data 510 may further restrict the external commands to which the vehicle may respond. For either data 508 or 510, method 300 may implement an access control list to restrict the available external commands, allowing only manual commands or limited capabilities based on authentication levels, which may be more restricted following the defection of a valid cyber-attack.

In accordance with some embodiments, an Override Autonomous Mode obedience mode may be governed by data 600 as shown in FIG. 6. This autonomous mode may be governed by an ADAS. While the following description may reference an ADAS, it is also applicable to other autonomous operating modes and systems.

Similar to cyber-attack mode, the activation of the override autonomous mode mode as indicated by block 602 may be governed by an access control list, as described above, that specifies criteria in order to access particular actions methods, or commands, that an external entity may provide to the vehicle, as indicated by block 604. Data block 606 may contain further criteria governing what commands the vehicle may accept in this mode. For example, data block 606 may contain information related to the complexity, or simplicity, of the monoverse (or environment) in which certain actions may be taken. This area may be small and may define the area in which the ADAS may be overridden. This includes, e.g., geo-fencing or other situational factors that govern whether the ADAS may be overridden. Actions may also be limited to, e.g., returning to a home base or other more permanent location, to a maintenance depot, or expanding the terrain over which the vehicle may operate. For example, the ADAS may limit the area of operation of the vehicle, and the override ADAS mode may expand that territory. Other ADAS features, such as braking or collision avoidance, may also be overridden in this mode subject to the appropriate command from an entity with sufficient authority to issue the command. Additionally, the command to override the ADAS does not need to be, necessarily, followed with further commands from the outside entity sending the cues or signals to the vehicle. For example, after overriding the ADAS, the vehicle perform automated tasks without the restrictions of the ADAS. In some embodiments, the override ADAS mode is implemented with an access control list to control access to the enablement/disablement of the ADAS system, and defines action methods to enable/disable the system in response to authorized cues/commands. Such features may be implemented with or without attaching external devices or requiring manual control of the vehicle.

In accordance with some embodiments, a hold your ground obedience mode may be implement according to data 700 as shown in FIG. 7. In Block 702, the hold your ground obedience mode is implemented according to various criteria that may be implemented in, e.g., an access control list. This mode may define an autonomous mode to hold ground using predefined criteria and access control list for access control. In this mode, the vehicles may be responsive to various commands governed by data 704, 706, 708, and 710. For example, as shown in block 704, the vehicle may enter a mode to seek help from another vehicle, unit, or entity such as a vehicle, nearest base, or person. Commands specified in data block 704 may also be based on predefined or dynamic criteria and an access control list. As another example, block 706 may provide data governing a stand down mode. In this mode, commands may be entered to that may deactivate offensive capabilities and/or cause retreat to a safe position. As another example, block 708 may contain data that governs commands related to patrolling. These patrols may be performed predesignated or dynamic geo-fenced areas and use access control lists controlling access to this functionality. Block 710 may govern an auto start/stop mode. In this mode, the vehicle may automatically start/stop various systems for battery conservation based on predefined conditions and an access control listing governing access to this functionality. Such conversation may help prolong communication with the vehicle and the time that the vehicle can be away from a charging and/or refueling station. This mode may also involve the autonomous advance or retreat of the vehicle based on situational analysis and an access control list.

In accordance with some embodiments, the vehicle may be placed in to a battlefield obedience mode governed by data 800 as shown in FIG. 8. For example, the vehicle may use an access control list and other predefined criteria as established by data 802 to enter this mode. Once in the battlefield mode, the vehicle may be capable of accepting commands according to data 804, 806, and 808 that may enable autonomous action by the vehicle. For example, data 804 may define executable commands for an offensive/attack mode, including a fight back mode, in which the vehicle may autonomously take action in these modes. According to data 806, the vehicle may be placed in battlefield oriented engagement, in which the vehicle could autonomously, or be directed to, self-destruct if, e.g., it detects or an external entity determines that the vehicle may be compromised. Similarly, the vehicle could enter a kamikaze mode. According to data in block 808, commands may be given to override the safety systems of equipment, including battlefield equipment. For example, a safety system related to the firing of a gun may be affected by this mode that could lessen, or heighten, the criteria for using the weapon. Such operations may use an access control list to control access to override commands for battle equipment and safety systems. Such access control list may define or list several criteria, for these commands to occur. For example, the vehicle may need to be in a particular mission mode for one or more of the safety commands to be overridden. This may allow the vehicle to take a destructive path to its target location and deploy to particular areas. Criteria specified in data 808 may include the location of the vehicle, proximity to the particular locations (e.g., enemy lines) or positions relative to the same.

In accordance with some embodiments, a “detect issues in battlefield” obedience mode is governed by data 900 as shown in FIG. 9. In this mode, issue detecting and alerting may use algorithms to detect issues or concerns in the environment as well as access control list controlled action methods to relay danger alerts to other vehicles, such as indicated by data 904. Cued commands may also involving relaying or communicating dangers to alert other vehicles or entities, as indicated by data 906. Similarly, data 908 may be used to create a check point or a warning point for other vehicles or entities. As indicated by data 910 and 912, this mode may define and restrict access to commands directed to using the vehicle as a shield (910) and/or setting priorities of protecting assets (912). Either data may define an access control list to control which actions can be command by which cues from external entities, and may define further criteria such as prioritization of asset protection, such as protecting lives before equipment, and more valuable equipment before less valuable equipment. For example, commands according to data 910 may allow the vehicle to act like a shield for people or other equipment as specified by an entity giving the vehicle the commands, allowing the vehicle to provide a defensive function in the face of an aggressor threatening violence. When prioritizing the protection of assets (as governed by data block 912), it may be valuable to place the autonomous vehicle in the most dangerous locations via an external cue providing a command to the vehicle. Lives may be protected before cargo, and cargo may be ranked by a value which may be predefined, or dynamically defined by the external entity given commands to the vehicle.

In accordance with some embodiments, one or more additional obedience modes may be implemented. For example, commands related to the deployment and positioning of the vehicle may be cued and accessed via an access control list to determine access to deployment and positioning commands based on factors like location, proximity to enemy lines, and asset priority.

Returning to FIG. 3, method 300 advances from block 301 to the Valid Cyber Attack decision block 304, the method 300 determines whether or not an valid cyber-attack is detected, which may restrict the types of external commands to which a vehicle will respond due to the vehicle being in a compromised state. Memory-stored Cyber Attack data file of FIG. 5 denotes that an cyber-attack trigger is recognized by the vehicle or an external entity, which may implement the process of executing commands as dictated by the cyber-attack data file of FIG. 5 according to the method steps of 316 to 332. The cyber-attack obedience mode may be check first at block 304 as the recognition of potentially compromised vehicle may affect the ability to enter, or may restrict the actions taken, the other obedience modes. In accordance with some embodiments, the decision as to whether each obedience mode is entered or not, as indicated by the decisions at blocks 304, 306, 308, 310, 312, and 314, may be independent from one another.

Upon receiving any predefined triggers activating any of the Obedience Modes, such as any of Cyber Attack block 304, an Automatic Trigger Block 306, Override ADAS block 308, Hold Your Ground block 310, Battlefield (or attack) block 312, and Battlefield Issue Detection block 314 being answered yes, method 300 proceeds to block 316 and the following blocks (e.g., 324, 326, and 328) to determine whether a command may be executed in accordance with the data governing such mode (as described above). Such commands may be directed, or be attempted to be directed, by a cue or signal sensed by the vehicle. Each of these obedience modes enables an entity outside of the vehicle to control predetermined operations of the vehicle using one or more visible, audible, and/or other cues (such as short range wireless communications). Each obedience mode may enable a restricted, unique set of vehicle operations, each of which may be elicited by a respective cue (audible, visual, or other) received from the external entity. Following activation of the obedience mode, the vehicle may execute a confirmation that the vehicle is ready for external control, such as that described for block 207 above with respect to FIG. 2. Such a confirmation by the vehicle may be unique to the activated obedience mode.

The method 300 may continue with further steps responsive to the activation of an obedience mode. For example, at block 316, the method may determine whether a successful authentication of the external entity has been performed. Different levels and types of authentication may be required based on the particular obedience mode(s) in which the vehicle is operating, as well as the particular command that the external entity is attempt to provide to the vehicle, as may be governed by the data block for that obedience mode. For example, a command to override safety systems may be subject to more rigorous access control techniques that a simple repositioning of the vehicle that does not override the ADAS and would not create a condition in which the vehicle could harm people or wreck equipment.

If authentication is not successful, at block 318 the vehicle may store data related to the unsuccessful authentication and/or enable the vehicle to enter a spy (or observance) mode. This step may be performed because lack of successful authentication may be indicative that the vehicle is compromised, or is in a compromising situation, such as being located near personnel who are not authorized to command the vehicle. Block 320 may cause the vehicle to enter a lock down mode if the vehicle detects, or if an external entity informs the vehicle that it is compromised. This lock down may restrict the actions the vehicle may perform, and may lead to an asset recovery or reconfiguration mode at block 322.

If authentication is successful, at block 324 the method checks whether the control of the vehicle is approved. If control is not approved, the method reverts to check whether an obedience mode is entered and, if so, returns to block 316.

If control is approved at block 324, method 300 proceeds to block 326 at which the vehicle determines whether a command have been received. In accordance with some embodiments block 326 may be substantially similar in its performance to block 209 as described above for FIG. 2. As stated above, commands and the cues that indicate those commands may varying depending on the obedience mode in which the vehicle is operated. Further, while those commands may be cued by audio and visual signals, other signals, such as direct interaction and/or contact with the vehicle or use of any of the above mentioned sensors, may also provide those cues that trigger commands according to the obedience mode data discussed above. Block 326 may also include, or be linked to, the time-out provisions such as those stated above with respect to block 211 of FIG. 2. Such features may serve to limit the time that the vehicle is operatized in an obedience mode before it reverts to another form of operation.

At block 328 it is determined that the command/cue is not valid (block 328=no), the vehicle may indicate failure at block 332 by providing an audible, visual, or other indication to external operator of the vehicle. Block 328 may be performed similarly to the valid command block 215 of FIG. 2. Further, method 300 may incorporate a failure threshold decision like block 221 of FIG. 2. Upon reaching such a threshold of invalid commands, method 300 may proceed to blocks 320 and 322 as reaching this threshold may be indicative that the vehicle may be in a physically comprised location or is otherwise being directed by an entity that may not have the authority or training to externally control the vehicle.

If the command is determined to be valid (block 328=yes), the method may, at block 330 execute the command in accordance with the obedience mode to which the command belongs. The execution of the this command may be similar to that described for block 217 as described with respect to FIG. 2.

Similar to method 200, and in particular blocks 211 and 221, method 300 may terminate external control of vehicle as in block 213 when no external command is detected and/or there are indications that the vehicle could be compromised or that an external user is not properly trained in the operation of the vehicle, e.g., when a number of command attempts that fail to provide a valid command reaches a certain threshold.

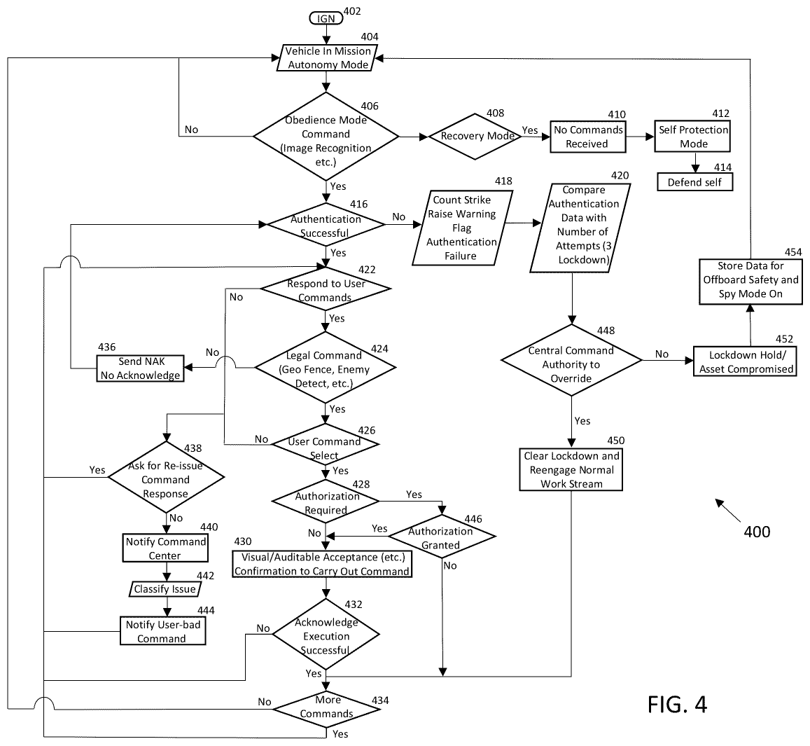

In accordance with some embodiments, FIG. 4 provides a method 400, another embodiment of an improved method or control strategy for provisioning external control of an autonomously operable vehicle, such as automobile 10 of FIG. 1, via an entity outside of yet proximal to the vehicle is generally described at 400 in accordance with an embodiment of the present disclosure. Some or all of the operations illustrated in FIG. 4 and described in further detail below may provide an example of an algorithm that corresponds to non-transitory, processor-executable instructions that are stored, for example, in main or auxiliary or remote memory (e.g., memory device 38 and/or database 98 of FIG. 1), and executed, for example, by an electronic controller, processing unit, dedicated control module, logic circuit, or other module or device or network of modules/devices (e.g., CPU 36 and/or cloud computing service 24 of FIG. 1), to perform any or all of the above and below described functions associated with the disclosed concepts. It should be recognized that the order of execution of the illustrated operation blocks may be changed, additional operation blocks may be added, and some of the herein described operations may be modified, combined, or eliminated. Further, Any of the blocks of method 400 may be combined with the above described methods of FIGS. 2 and 3, and vice versa.

The method may start at block 402 in which case the ignition of the vehicle is turned on. As a default, the vehicle may start in an autonomous mode at block 404 that may resemble more traditional autonomous vehicle functionality. The method 400 continuously monitors for a cue or signal to place the vehicle in a obedience mode at block 406. Block 406 may be similar to block 302 discussed above for FIG. 3. This monitoring may use, e.g., access control lists and external cues from entities attempt to interact with the vehicle. These obedience modes may be similar to the obedience modes discussed above with respect to FIGS. 2 and 3. In some embodiments, the signal indicating that the vehicle is controllable the one or more operating modes is received from a remote back office, control center, or command center that may control and/or authenticate the vehicle operating in such modes.

If no such acceptable interaction is detected, the vehicle may be directed to enter a recovery mode at block 408, or it may enter the recovery mode on its own if not direction to enter an obedience mode it detected after a certain period of time and/or after a number of failed interactions or no commands are received as indicated by block 410. In such a mode, the vehicle may enter into a self-protection mode at block 412, during which it may defend itself from harm at block 414 until the vehicle is recovered and/or an appropriate obedience mode is commanded. In some embodiments, the vehicle may return to an autonomously operating mode.

If a command or signal to enter an obedience mode is detected at block 406 (block 406=yes), then method 400 proceeds to check the authentication, at block 416, of the entity attempting to control the vehicle. This authentication may be similar to the authentication check at block 316 discussed above with respect to FIG. 3.

If the authentication is not successful, at block 418 a count strike may be incremented, which may raise warning flag of the failed authentication. This count may be compared against a predetermined threshold at block 420. If the threshold is exceeded, a central command authority may be contact at block 448. If the central command authority so desires, it can clear the lock down at block 450 and cause the vehicle to search for more commands (block 434). Alternatively, the central command authority may order the vehicle to enter a lockdown mode at block 452 because the vehicle may be composed. At block 454, the vehicle may also store the data or enter a spy mode to gather data regarding the failed authentication. The vehicle may also enter a recovery mode as discussed above with respect to FIG. 3. In some embodiments, blocks 452 and 454, and any potential recovery mode, may be entered without an affirmative command from the central authority. Rather, the vehicle may take such action upon the failure to receive from the central authority the direction of block 450 to clear to the lockdown and/or counter. If in a lockdown mode, the vehicle may also direct itself to protect valuable information or equipment that it may be carrying, such as by destroying this information or equipment.

If authentication is successful, the method 400 may move to block 422 to determine whether to respond to the cue/signal provided the entity attempting to control the vehicle and execute the directed command. This determination may involve several other determinations. For example, in block 424, a determination may be made regarding whether the command directed by the cue meets certain legal requirements, such as identification of appropriate targets and/or their location in an authorized location, which may be determined by a geo-fence. At block 426, it may also be determined whether the command is selected by a user and, if so, at block 428 whether higher level authorization is required. For example, if the command is to override a safety system, such a command may require higher authority permission prior to performing this action. This higher level authority may be internal to the vehicle, another external but still local entity, or a remote entity such as a central command. If additional authorization is required, method 400 proceeds to decision block 446. If the additional authorization is not granted, the process proceeds to block 434 to check for further commands. In some embodiments, failure to successful grant permission from a higher authority may increase an incremental counter, like that used for authentication, that may lead to actions similar to those provided by blocks 420, 458, 450, 452, 454, and possible asset recovery.

If additional authorization is granted, or if no additional authorization is required, method 400 proceeds to block 430, in which the vehicle provides an indication (e.g., audible, visual, or other) of acceptance of the command which the vehicle carries out In block 432, the vehicle may provide an indication of whether the vehicle did or did not successfully carry out the command, prior to proceeding to check whether more commands are received at block 434. When no more commands are detected, method 400 reverts block 404 in which the vehicle operates in an autonomous mode.

Returning to blocks 422 and 426, if either block is not successful, method 400 proceeds to block 438 at which the vehicle may ask for, or provide an indication that, the command should be re-issued. If no notification is provided, the method may involve, at block 440 notifying a command center or central command authority of the failure. At block 442, the command center may classify the issue and then, at block 444 notify the user of the bad command and/or provide the correct command the vehicle before returning to block 422 to wait for more commands.

In various embodiments described above, autonomous system, which may be defensive systems, encompasses a range of features designed for adaptability and resilience in scenarios in which the control of the vehicle may be contested. The system may include capabilities such as remote ADAS system control (enabling/disabling), cyber-attack recognition triggering a Defense Restricted Mode, and various autonomous modes for different situations. Power management may be employed to ensure prolonged communication, while patrolling and battlefield engagement features/modes allow for flexible responses to threats. Conflict detection and response mechanisms/modes enable proactive identification of issues and relay of danger to other vehicles. Asset protection and prioritization modes ensure the safety of valuable cargo and resources, with the system capable of adjusting strategies based on threat levels and mission objectives. Overall, the system aims provides a comprehensive defense capabilities while prioritizing safety and mission success in a manner which can be controlled externally using cues, such as audible and visual signal. While some of the embodiments described above for battlefield scenarios, a person of ordinary skill will recognize that the above teachings may be applied to other scenarios in which, e.g., a relaxation of safety requirements may be warranted.

Various benefits are provided by the embodiments disclosed herein. Among these are: Security Enhancement: prevention or reduction in unauthorized access and reducing cyber-attack risks to control, including the external control, of autonomous vehicles; Cybersecurity Resilience: detecting and responding to cyber-threats effectively; Operational Flexibility: adapting to various scenarios autonomously and in response to external cuing, including in contested environments, for enhanced mission effectiveness; Resource Optimization: prolonging mission duration and increase operational efficiency; Tactical Advantage: engaging in offensive and defensive actions autonomously in a well-regulated and controlled manner; Safety and Risk Mitigation: taking decisive actions in high-risk situations thereby ensuring safety to personnel and equipment; Mission Effectiveness: optimizing mission execution and increasing situational awareness; Threat Detection and Alerting: enhancing situational awareness and enabling a more and better coordinated responses; and, Asset Protection and Prioritization: prioritizing critical assets, minimizing losses and maximizing mission objectives.

Embodiments disclosed herein provide the capability to control a vehicle safely and securely from the outside using hand motions and signals while avoiding counter detection threats in contested situations, providing for the ability to operate and move a vehicle without needing to enter the same. This provides for greater case of use and mobility of autonomous vehicles for various purposes including delivery of medical and food supplies, as well as responding to natural disasters and providing for more effective evacuation and rescue, including in hostile environments.

In some non-limiting examples, herein described visible cues may include hand gestures, head motions, body movements, hand-drawn or hand-held signage, commands displayed via an electronic display, etc. In some non-limiting examples, herein described audible cues may include verbal commands, oral sounds (e.g., whistles), human-made sounds (e.g., claps, leg slaps, finger snaps, foot stomps), sounds output via an audio speaker, etc. As another option, any of the herein described external control modes may enable an external entity to execute a preset N number of commands (e.g., next five (5) commands preapproved by central command authority). Another option may include the ability to propagate a gesture-based command from a lead (first) vehicle to one or more coordinated (second, third, fourth, etc.) vehicles in a formation. The control system may be programmed such that one or more commands may not be executed in predefined areas or may impose a higher authority of approval for activation. As yet another option, a wireless-enabled, third-party “talking” vehicle may be operable to connect to the host vehicle, e.g., using V2V comm protocols, to approve external control of the host vehicle or to act as a target vehicle followed by the host/surrogate vehicle.

In at least some embodiments, an intelligent vehicle control system may manage conflicting commands using overrides or cloud relays seeking intervention. If a command conflict cannot be resolved with either of the foregoing “default” protocols, the host vehicle may contact a BO vehicle command center for conflict resolution. As another option, an intelligent vehicle control system may indicate (e.g., via light, horn, wheel movement, etc.) a request for external control or a visible/audible command will necessitate an additional/supplemental “confirmation” to proceed, e.g., if the vehicle controller determines that a requested maneuver is risky or prohibited. If a threshold of identification is not met, the host vehicle may indicate that supplemental approval or an override is needed.

In some embodiments, conflicting commands may be addressed by prioritizing commands from individuals with higher levels of authorities, such as ranks of an individual and/or positional authority. Access control list or databases may use additional criteria, facial recognition, name tapes, country indicators, infrared markers, and other indications as part of the access control decision.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software, or a combination thereof, in a computer system or other processing system.

Any of the methods described herein may include machine readable instructions for execution by: (a) a processor, (b) a controller, and/or (c) any other suitable processing device. Any algorithm, software, control logic, protocol or method disclosed herein may be embodied as software stored on a tangible medium such as, for example, a flash memory, a solid-state drive (SSD) memory, a hard-disk drive (HDD) memory, a CD-ROM, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms may be described with reference to flowcharts and/or workflow diagrams depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

1. A method of controlling a autonomously operable vehicle, comprising:
receiving, by the vehicle, a signal indicating that the vehicle is controllable in one or more of a number of operating modes;
receiving, by the vehicle, a cue to operate the vehicle in one or more of the number of operating modes;
receiving, by the vehicle, a first command;
determining, by the vehicle, whether the first command is executable;
performing, by the vehicle, the first command after the vehicle determines that the first command is executable.

2. The method of claim 1, wherein the cue and/or executable command is generated by a source other than the vehicle.

3. The method of claim 1, wherein the operating modes each define a unique set of actions that the vehicle may perform.

4. The method of claim 1, further comprising verifying, by the vehicle, the authentication of the source of either the cue and/or first command, prior to performing the command.

5. The method of claim 4, wherein, if the vehicle is unable to verify the authentication of the source of either the cue and/or first command, transmitting, to an external authority, an indication of the failed verification.

6. The method of claim 4, wherein, if the vehicle is unable to verify the authentication of the source of either the cue and/or first command, providing an indication at the vehicle, of the failed verification.

7. The method of claim 1, wherein the first command is indicated by the cue received by the vehicle.

8. The method of claim 1, further comprising determining, by the vehicle, whether an executable second command has been received before the performance of the first command and, prioritizing the performance of the second command over the performance of the first command.

9. The method of claim 1, further comprising providing an indication, by the vehicle, of the reception of the cue and/or determination that the first command is executable.

10. The method of claim 1, further comprising providing an indication, by the vehicle, that the first command is not executable.

11. The method of claim 1, further comprising entering a protection mode in response to a second cue.

12. The method of claim 1, further comprising entering a conservation mode when the vehicle is not in receipt of an executable command.

13. The method of claim 1, determining, by the vehicle, whether the first command is executable comprises determining a successful authentication of the source of the first command and that the signal is a valid command.

14. The method of claim 1, further comprising referencing an access control list to determine whether the source of first command is authorized to issue the first command.

15. The method of claim 14, wherein a determination that the source of the first command is not authorized to issue a first command cause the vehicle to enter an observance mode.

16. The method of claim 1, further comprising entering a recovery mode if the vehicle is determined to be compromised.

17. The method of claim 1, wherein the first command overrides an autonomous mode of the vehicle.

18. The method of claim 1, further comprising accessing a remote, external authority prior to performing the first command.

19. A vehicle controller configured to:
receive a signal indicating that the vehicle is controllable in one or more of a number of operating modes, each operating mode defining a unique set of actions that the vehicle may perform;
receive a cue to operate the vehicle in one or more of the number of operating modes;
receive a first command;
determine whether the first command is executable;
perform the first command after the vehicle determines that the first command is executable.

20. Non-transitory, computer-readable media for storing instructions executable by one or more processors of a vehicle controller, causing the vehicle controller to perform operations comprising:
receiving a signal indicating that the vehicle is controllable in one or more of a number of operating modes, each operating mode defining a unique set of actions that the vehicle may perform;
receiving a cue to operate the vehicle in one or more of the number of operating modes;
receiving a first command;
determining whether the first command is executable;
performing the first command after the vehicle determines that the first command is executable.
